(19) United States
(12) Patent Application Publication
(10) Pub. No.: US 2004/0195394 A1
(43) Pub. Date: Oct. 7, 2004

(54) Fluid dispenser

(75) Inventors: Gerard Cornet, Blaru (FR); Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 10/779,846

(22) Filed: Feb. 18, 2004

Related U.S. Application Data
(60) Provisional application No. 60/464,334, filed on Apr. 22, 2003.

(30) Foreign Application Priority Data
Feb. 20, 2003 (FR) FR-03/02080

(51) Int. Cl. B05B 1/30

(52) U.S. Cl. 239/569

(57) ABSTRACT

A fluid dispenser comprising: a fluid reservoir; at least one dispensing orifice through which the fluid is dispensed; a fluid feed duct (12) connecting the reservoir to the dispensing orifice, said duct being provided with an inlet and with an outlet; a valve (31, 61) for selectively closing off the feed duct, said valve comprising a moving valve member (31) mounted to move between a passageway-closure position and a passageway-opening position, the moving valve member being mounted to be moved in translation along a valve axis; and actuating means (4) for moving the moving valve member (31) between the passageway-closure position and the passageway-opening position; said fluid dispenser being characterized in that the actuating means can be moved transversely to said valve axis, the actuating means comprising force-transmitting means suitable for transforming a force exerted on the actuating means into a transverse thrust force exerted on the moving valve member to move it towards its passageway-closure position.

### CROSS REFERENCE TO RELATED APPLICATION

This application claims the benefit under 35 U.S.C. §119(e) of pending U.S. provisional patent application Serial No. 60/464,334, filed Apr. 22, 2003, and priority under 35 U.S.C. §119(a)-(d) of French patent application No. FR-03.02080, filed Feb. 20, 2003.

### TECHNICAL FIELD OF THE INVENTION

The present invention relates to a fluid dispenser comprising a fluid reservoir, at least one dispensing orifice through which the fluid is dispensed, a fluid feed duct connecting the reservoir to the dispensing orifice, a valve for selectively closing off the feed duct, and actuating means for moving the valve between a passageway-closure position and a passageway-opening position. Such a dispenser can be used, in particular, in the fields of perfumes, of cosmetics, or indeed of pharmaceuticals.

The present invention applies more particularly to a dispenser having a vibratory plate for generating vibration in the fluid so as to dispense it through the dispensing orifice(s). In order to start the plate vibrating, vibrator means are generally provided in the form of a piezoelectric element or of an ultrasonic resonant element. However, the invention is not limited to this particular type of dispenser having a vibratory plate. It is applicable to other types of dispenser that do not have vibratory plates.

### BACKGROUND OF THE INVENTION

Such a particular type of dispenser having a vibratory plate is known from Document FR 2 820 408 which describes a dispenser comprising a fluid reservoir, a dispensing member having a perforated vibratory plate, a feed duct connecting the reservoir to the vibratory plate, and an intake valve suitable for opening and closing the passageway formed by the feed duct. That valve comprises a metal ball urged by a spring against a valve seat formed inside the feed duct. To disengage the ball from its seat, electromagnetic means are provided that make it possible to attract the ball away from its seat. The ball moves axially inside the duct, and the actuating means are controlled electrically.

### SUMMARY OF THE INVENTION

The present invention proposes an alternative solution to electrically controlling the intake valve consisting in actuating means that are exclusively mechanical, and that make it possible to lift the valve away from its seat.

In the invention, the fluid dispenser comprises: a fluid reservoir; at least one dispensing orifice through which the fluid is dispensed; a fluid feed duct connecting the reservoir to the dispensing orifice, said duct being provided with an inlet and with an outlet; a valve for selectively closing off the feed duct, said valve comprising a moving valve member mounted to move between a passageway-closure position and a passageway-opening position, the moving valve member being mounted to move in translation along a valve axis; and actuating means for moving the moving valve member between the passageway-closure position and the passageway-opening position; the actuating means being mounted to move transversely to said valve axis, the actuating means comprising force-transmitting means suitable for transforming a force exerted on the actuating means into a transverse thrust force exerted on the moving valve member to move it towards its passageway-closure position. Thus, the valve member is moved axially by exerting a transverse and advantageously perpendicular force on the actuating means. The force-transforming means making it possible to move the valve member are clearly different from some other mechanical technical solution consisting in moving a valve member transversely in front of an outlet of a feed duct like a slide.

In an aspect of the invention, the moving valve member comes into leaktight abutment against a fixed valve seat, formed at the outlet of the feed duct, when in the passageway-closure position, and remains away from said seat when in the passageway-opening position. Advantageously, the moving member is urged resiliently into the opening position by spring means.

In a practical embodiment, the force-transforming means comprise a cam system. Advantageously, the cam system comprises a cam element secured to the moving member and a cam piece formed by the actuating means. Preferably, the cam piece can be moved in translation and transversely relative to the cam element. However, in a variant, the cam piece can be moved in rotation and transversely relative to the cam element.

In the former case, the actuating means can be moved in translation in the manner of a drawer or of a slide. In the latter case, the actuating means may be in the form of a wheel that can be turned about its axis.

In another aspect of the invention, the actuating means further comprise a control element that is accessible from outside the dispenser. The control element may be in the form of a button or knob to be pushed or pulled, or else in the form of a segment of periphery of a wheel that can be turned by using a finger.

In another embodiment of the invention, the dispenser comprises a closure member serving to come into place selectively in front of or behind said at least one dispensing orifice to close it off. This closure member directly contacts the surface surrounding said dispensing orifice and thus closes the passage between the feed duct 12 and the orifice. This closure member may be implemented independently from the valve, because it has a similar function. Advantageously, the cam piece and the closure element are constrained to move together. Thus, by actuating the actuating means, both the feed duct and the dispensing orifice(s) are closed off.

In an advantageous embodiment, the actuating means are made integrally as a single piece.

In another aspect of the invention, the moving member is secured to a support piece on which a piece of porous material is mounted that can be impregnated with fluid, said piece being urged resiliently into contact with said at least one dispensing orifice. Advantageously, the support piece is provided with common spring means for simultaneously urging the piece of porous material against said at least one dispensing orifice and urging the moving member into the passageway-opening position. Advantageously, the support piece forms an outlet channel connecting the outlet of the duct to the piece of porous material, the moving member being mounted inside said channel. Advantageously, the channel has an elastically-deformable portion making it possible to move the moving member and the piece of porous material. Advantageously, the support piece is provided with an elastically deformable diaphragm having an outer peripheral edge that is held in fixed manner, said diaphragm moving the moving member and the piece of porous material in translation axially. Thus, the support piece may also be made integrally as a single piece by integrating the moving member, the common spring means, the outlet channel, the support for the piece of porous material, and the elastically deformable diaphragm.

In a preferred embodiment, the dispenser further comprises a vibratory plate that generates vibration in the fluid, said plate advantageously being vibrated by a piezoelectric element. Advantageously, said at least one dispensing orifice is formed through the vibratory plate. The use of such an intake valve controlled by control means that are exclusively mechanical is particularly advantageous when the dispenser has a vibratory plate which is advantageously perforated for dispensing the fluid in the form of a spray. This avoids any risk of the fluid leaking when the dispenser is not being used.

### BRIEF DESCRIPTION OF THE DRAWINGS

The invention is described more fully below with reference to the accompanying drawings which give a non-limiting example of an embodiment of the invention.

In the figures:

FIG. 1 is an overall section view of a fluid dispenser of the invention;

FIG. 2 is a greatly enlarged vertical section view of the dispensing portion of a fluid dispenser of the invention in the in-use position;

FIG. 3 is a view similar to the FIG. 2 view looking along a section line that is slightly offset relative to the line of FIG. 2;

FIG. 4 is a view similar to the FIG. 2 view on the same section line, when the dispenser is in the actuating position;

FIG. 5 is a view similar to the FIG. 3 view, in the rest position;

FIG. 6 is a perspective view of the support piece used in the dispenser of the present invention;

FIG. 7 is another perspective view of the support piece;

FIGS. 8 and 9 are perspective views seen looking from different angles of the actuating means for actuating the dispenser of the present invention;

FIG. 10 is a perspective view showing the support piece and the actuating means in the actuating position;

FIG. 11 is a perspective view similar to the FIG. 10 view, in the not-in-use rest position;

FIG. 12 is another perspective view similar to FIG. 11; and

FIG. 13 is another perspective view similar to FIG. 10.

### DETAILED DESCRIPTION OF THE INVENTION

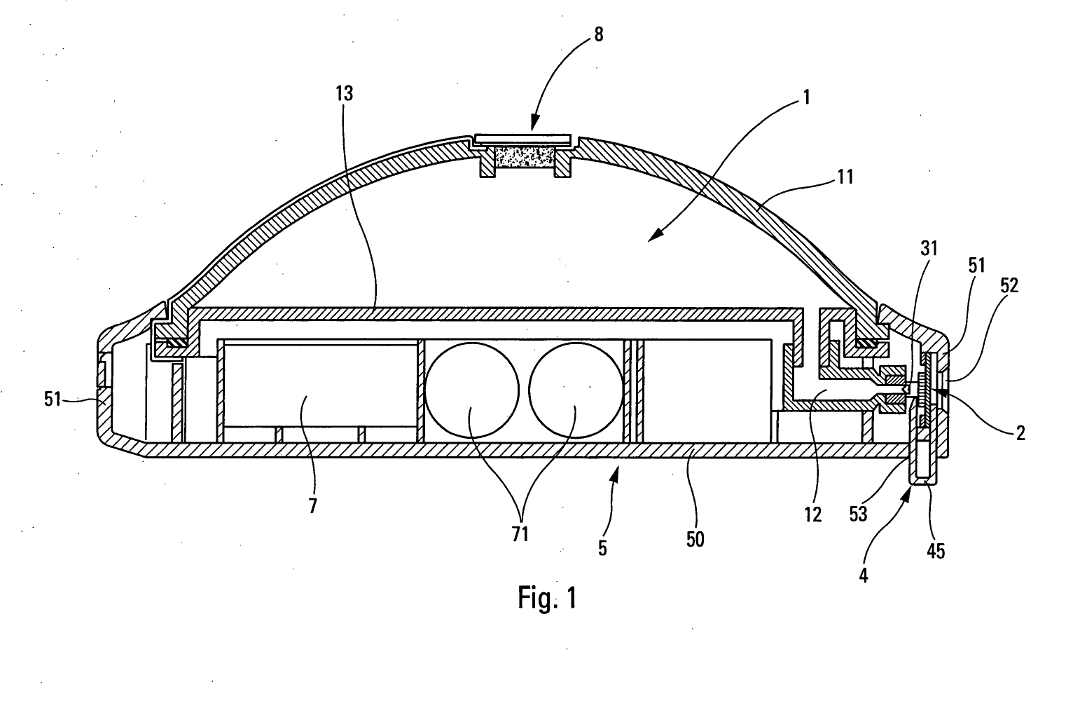

The fluid dispenser of the invention shown in FIG. 1 comprises a fluid reservoir 1 having a bottom wall or bottom 13 and a dome-shaped top wall 11, the walls defining between them the working volume of the reservoir. Naturally, the particular shape of the reservoir should not be considered to be limiting, so that the reservoir may be of any shape without going beyond the ambit of the invention. The top wall 11 of the reservoir is also provided with an actuating button 8 which is an electrical actuating button, as explained below. In addition, a venting passageway may be formed at the top wall 11 under the actuating button 8.

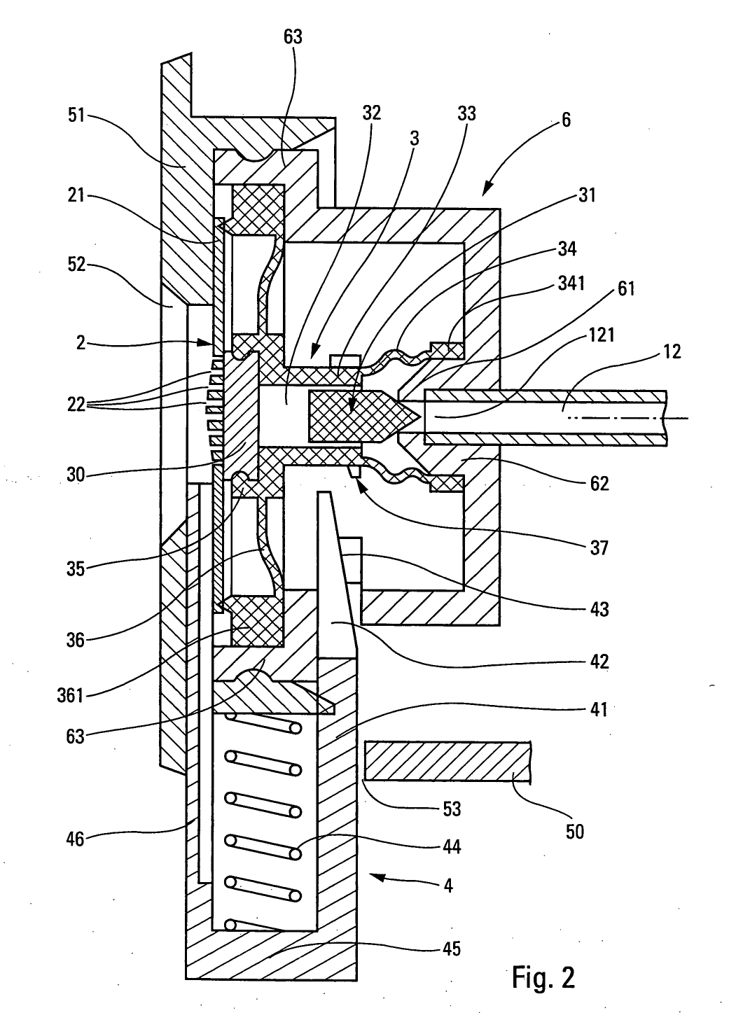

The dispenser further comprises a bottom shell 5 on which the reservoir 1 is mounted so as to define a plurality of compartments between the bottom wall 13 and the bottom shell 5. The bottom shell 5 has a substantially plane bottom wall 50 which serves as bearing surface on which the dispenser stands when it is put down on a substantially plane surface. The bottom shell 5 is also provided with a peripheral edge 51 to which the reservoir 1 is fixed. Among the compartments defined between the bottom wall 13 and the bottom shell 5, there is a compartment containing control electronics 7 making it possible to control the dispenser. In an adjacent compartment, there are two batteries 71 for powering the dispenser. In its right portion, as shown in FIG. 1, the dispenser also forms a feed duct 12 which leads from the reservoir 1 so as to feed the fluid to a composite dispensing member which makes it possible to dispense fluid from the dispenser. The dispensing member is disposed between the outlet of the duct 12 and a window 52 formed in the edge 51 of the bottom shell 5. The composite dispensing member is shown greatly enlarged and seen from a different angle in FIGS. 2 to 5 which show the dispensing member in the rest position and in the in-use position on offset section planes. Reference is therefore made below to FIGS. 2 to 5 to describe in detail the structure and operation of the composite dispensing member of the invention.

The composite dispensing member in this non-limiting embodiment of the invention comprises a vibratory plate 2 which, in this example, is advantageously perforated with a plurality of dispensing orifices 22. The dispensing orifices 22 may, for example, be arranged in the form of a grid-like array made up of rows and of columns of dispensing orifices. The vibratory plate, which may be flexible to some extent, may be associated with a vibration-generating element such as a piezoelectric element or a resonating element that resonates at very high frequency, such as an ultrasonic element. However, the vibratory plate may preferably be constituted by a piezoelectric layer associated with a non-piezoelectric layer so that the resulting plate is subjected to deformation by flexing when fed with a given current and with a given frequency. The plate 2 is held at its peripheral edge 21 so as to be fixed against the edge 51 of the bottom shell 5. Thus, when fed appropriately with current, with voltage, and with frequency, the vibratory plate starts to vibrate by means of a flexing deformation phenomenon, thereby ejecting fine droplets of fluid through the array of dispensing orifices 22. Naturally, for this purpose, it is necessary for the fluid coming from the reservoir 1 to be fed onto the rear face of the vibratory plate 2, i.e. its face facing towards the inside of the dispenser. The face facing towards the outside of the dispenser is situated in the window 52 formed by the bottom shell 5.

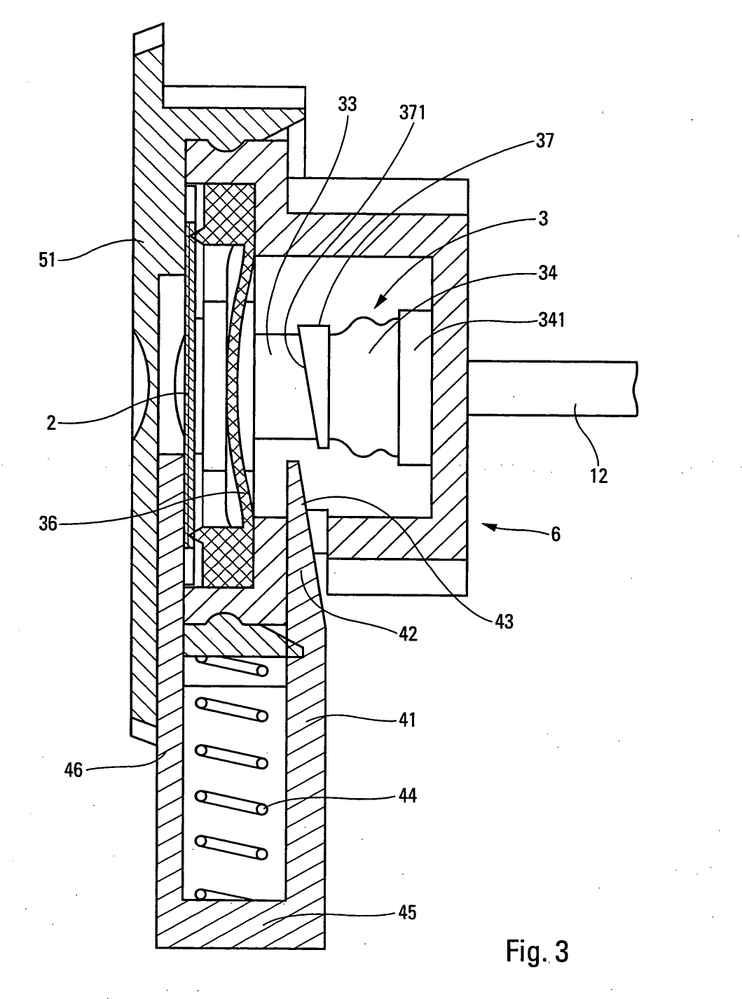

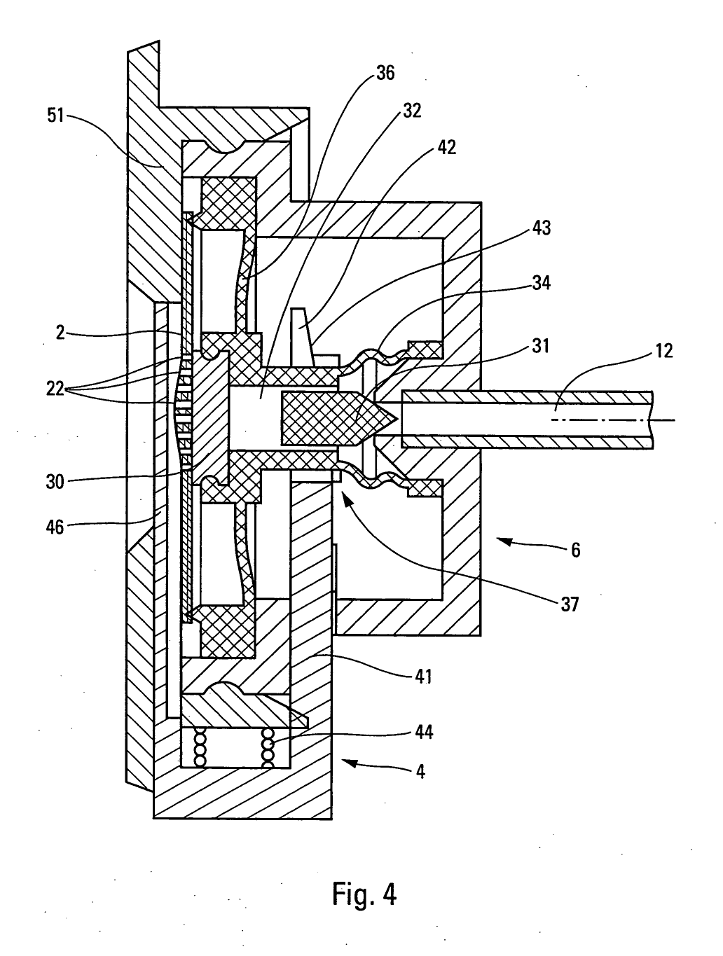

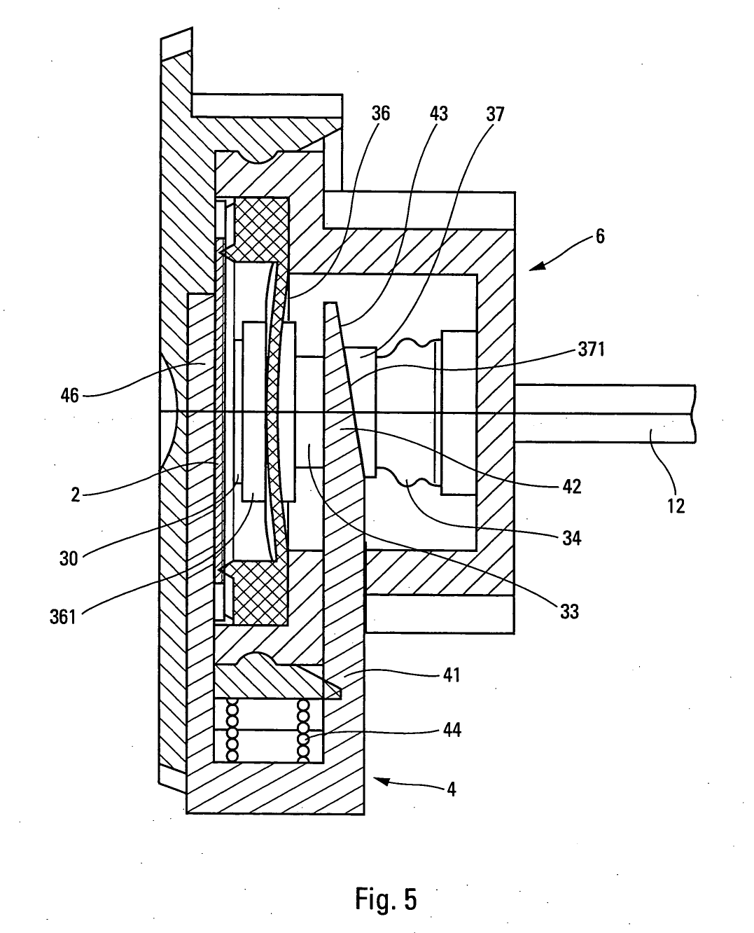

To feed the fluid onto the rear face of the vibratory plate 2, the outlet end 121 of the feed duct 12 communicates with the rear face of the vibratory plate 2 via an outlet channel 32 which connects the duct 12 to the plate 2. The outlet channel 32 is formed by a sleeve 33 which is an integral part of a support piece 3. More precisely, the outlet end 121 of the feed duct 12 is engaged in a ring 6. The ring is engaged at its outer peripheral edge 63 with the edge 51 of the bottom shell 5. The ring 6 forms an end-piece 62 inside which the end 121 of the duct 12 is in leaktight engagement. In addition, the end-piece 62 forms an intake valve seat 61 which is situated immediately after the end 121 of the duct 12. The support piece 3 forms a leaktight fixing collar 341 in engagement around the end-piece 62 of the ring 6. The collar 341 forms the upstream end of the sleeve 33 internally defining the outlet channel 32. The support piece 3 forms an elastically deformable segment 34 which nevertheless has shape memory so as to provide a return spring function. Beyond this return spring segment 34, the sleeve 33 forms a portion that is more rigid and therefore substantially non-deformable, inside which a needle 31 is formed that acts as a moving valve member designed to come selectively into leaktight bearing contact against the valve seat 61 formed by the ring 6. In FIGS. 2 and 3, the needle 31 is away from the seat 61, while in FIGS. 4 and 5 the needle is in leaktight contact against its seat 61. In the invention, the return spring segment 34 urges the needle 31 away from the seat 61 so as to open up a passageway for the fluid at the outlet of the duct 12. This position corresponds to the dispensing member being in the actuating position or in the in-use position. The needle 31 which acts as a moving valve member occupies a portion of the cross-section of the sleeve 33 so that an annular passageway is formed between the needle 31 and the sleeve 33 so as to enable the fluid coming from the duct 12 to pass beyond the needle 31 towards the vibratory plate 2. Spacers may connect the needle to the sleeve.

The support piece 3 also forms a fixing recess 35 for an piece of porous material 30. The fixing recess 35 is formed at the downstream end of the sleeve 33. The piece of porous material 30 which is received in fixed manner in the recess 35 closes off the outlet of the channel 32, so that the fluid coming from the duct 12 and passing around the needle 31 has to penetrate into the piece of porous material 30. In this way, the piece of porous material 30 becomes impregnated or soaked with fluid. Preferably, the piece of porous material 30 has capillary absorption properties. The piece of porous material 30 is urged by the return spring segment 34 formed by the support piece 3 into contact with the rear face of the vibratory plate 2, where the dispensing orifices are formed. Therefore, the return spring segment 34 both urges the needle 31 away from its seat 61 and urges the piece of porous material 30 into contact with the perforated vibratory plate 2.

The support piece 3 also forms a corolla-like diaphragm 36 which extends radially outwards from the fixing recess 35 and forms at its outer periphery a fixing bead 361 engaged between the ring 6 and the peripheral edge 21 of the vibratory plate 2. More precisely, the fixing edge 63 of the ring 6 pushes the bead 361 into bearing contact against the periphery 21 of the vibratory plate 2. The diaphragm 36 may have a resilient return function for assisting the return segment 34. However, the diaphragm 36 also has a function for guiding the sleeve 33 or holding it in alignment so that the piece of porous material 30 always comes into contact with the vibratory plate 2 at the same place, and can move along an axis perpendicular to the plane of the plate 2. The axis along which the piece of porous material 30 moves coincides with the axis along which the needle 31 moves. The sleeve 33 moving in axial translation in this way is made possible by the elastic deformation characteristics of the segment 34 and of the diaphragm 36. However, the sleeve 33 is held in fixed manner at its two ends, i.e. at the collar 341 and at the bead 361.

As explained above, the support piece 3 that supports both the moving valve member, namely the needle 31, and the piece of porous material 30, can move in translation axially along an axis that is substantially perpendicular to the plane of the vibratory plate 2.

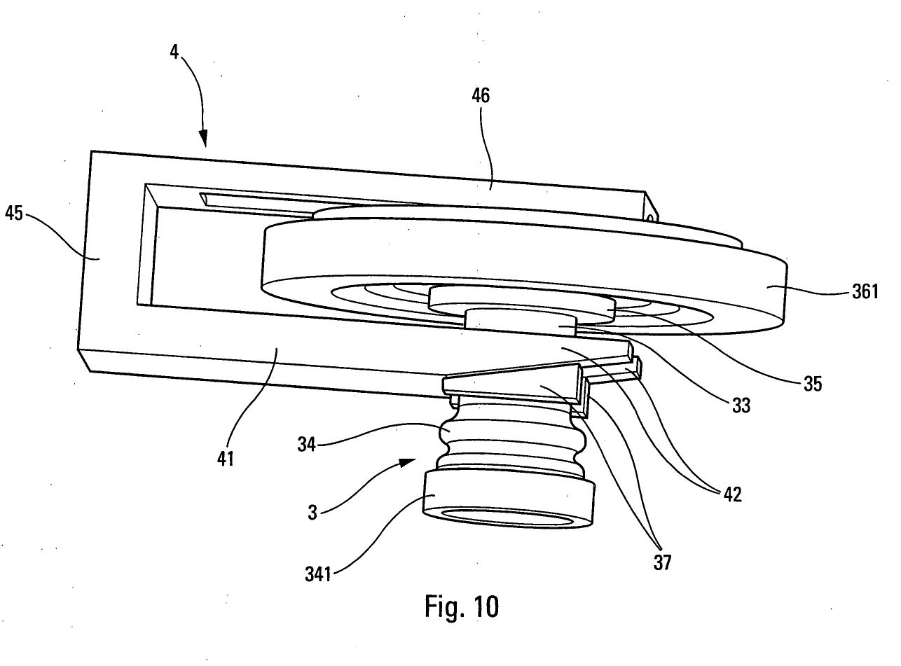

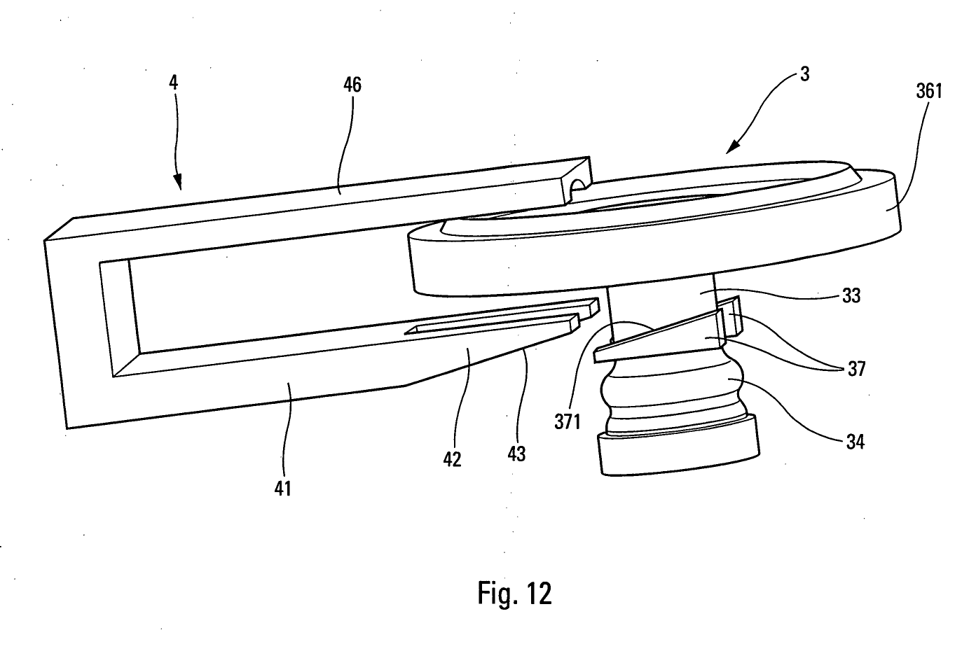

The composite dispensing member of the invention further comprises actuating means 4 which make it possible to move the sleeve 33 between a starting first position in which the piece of porous material 30 is in contact with the vibratory plate and the needle 31 is away from the seat 61 and a final second position in which the needle 31 is in leaktight abutment against the seat 61 and the piece of porous material 30 is away from the rear face of the vibratory plate 2. The actuating means 4 are mechanical actuating means that do not use electrical energy or electromagnetic energy. The actuating means 4 can be moved relative to the sleeve 33 of the support piece 3 in a plane that is transverse and preferably perpendicular to the axis along which the sleeve 33 moves. In the embodiment shown in the figures, the actuating means 4 comprise an actuating arm 41 adapted to move in translation by sliding along an actuating axis that is perpendicular to the axis along which the valve member and the piece of porous material move. The actuating arm 41 co-operates with the support piece 3 to form a force-transforming system making it possible to transform a force exerted along one axis into a force exerted along a transverse and preferably perpendicular other axis. More precisely, in this example, the force-transforming system is in the form of a cam system, one portion of which is formed by the actuating means 4, the other portion being formed by the support piece 3. In the practical embodiment shown in the figures, the actuating arm 41 forms a cam piece 42 which is in the general form of a two-pronged fork. Each prong of the cam piece 42 forms a sloping cam surface 43. The two prongs formed by the cam system 42 are spaced apart form each other and disposed such that the actuating arm 41 can move towards the sleeve 33 so that the sleeve 33 can be received between the two prongs. In corresponding manner, the support piece 3 forms two cam elements 37 which are in the form of two wedges, each of which defines a cam surface 371. The two wedges forming the cam element 37 are disposed on either side of the sleeve 33, as can be seen in FIGS. 10, 11, and 12. The actuating arm 41 can be moved in translation so that the cam surface 43 comes into contact with the cam surface 371, and so that the surfaces remain in contact with one another while they slide relative to each other over a certain distance. In this manner, while the arm 41 is moving towards the support piece 3, the cam piece 42 with its cam surfaces 43 moves the cam element 37 in translation along the axis along which the sleeve can move 33. This movement in translation takes place towards the feed duct 12 so that the needle 31 is moved into contact with its seat 61, and so that the piece of porous material 30 is moved away from the rear face of the vibratory plate 2. The cam piece 42 acts entirely conventionally on the cam element 37 as can be understood easily by any person skilled in the art. While the cam member 37 is moving, the return spring segment 34 is deformed elastically and it remains under stress so long as the actuating arm 41 has not been withdrawn to release the cam element 37 formed by the support piece 3. FIGS. 2 and 3 show the cam arm 41 not in engagement with the support piece 3, so that the needle 31 is away from its seat 61, and the piece of porous material 30 is in contact with the rear face of the vibratory plate 2. FIG. 2 is a view in section through the needle 31, and FIG. 3 is a view in section through a prong and through a wedge formed respectively by the cam system 43 and by the cam element 37. Conversely, FIGS. 4 and 5 show the actuating arm 41 advanced into engagement with the support piece 3. FIG. 4 is a view in section through the needle 31, and FIG. 5 is a view in section through a prong and through a wedge formed respectively by the cam system 42 and by the cam element 37.

The cam system 42 is received between the cam element 37 and the fixing recess 35.

The actuating means 4 further comprise an actuating element 45 via which the actuating means 4 can be actuated manually or mechanically. For example, the control element 45 may be accessible from outside the dispenser through an opening 53 provided in the bottom 50 of the bottom shell 5, as can be seen in FIG. 1. Thus, the actuating means 4 are actuated automatically whenever the dispenser is put down on a plane surface. In this way, whenever the dispenser is at rest, the actuating means are moved so that the cam system 43 comes into engagement with the cam element 37, and urges the needle 31 into leaktight abutment against its seat 61. Conversely, whenever the dispenser is picked up, the actuating means are urged resiliently by a spring 44 so as to disengage the cam system 43 from the cam element 37, so that the needle 31 can return into a position in which it is disengaged from its seat 61 and the piece of porous material 30 is in contact with the rear face of the vibratory plate 2. Any type of re-wetting means (not shown) are provided to hold the actuating means in the pushed-in or engaged position against the drive from the spring 44. This is merely a particular embodiment. naturally, the control element 45 may be situated anywhere on the dispenser. For example, it may be actuated manually by the user using a finger.

According to another characteristic of the invention, the dispenser comprises a closure member 46 able to be located in front of or behind the perforated vibratory plate, and more generally in front of or behind said dispensing orifice(s). The closure member may move along the valve axis or along a perpendicular axis. According to a practical embodiment, the actuating means 4 also form a closure flap 46 which can be slid in translation to come into position in front of the perforated vibratory plate 2. The closure flap 46 can be moved with the arm 41 by actuating the control element 45. Thus, when the cam system 43 is in engagement with the cam element 37, the closure flap 46 is situated in front of the vibratory plate 2. This is shown in FIGS. 4 and 5. Naturally, this corresponds to the fluid dispenser being in the rest position. The closure member may be implemented instead of the valve, or together with the valve. The closure member or closure flap may be fixed to the sleeve 83.

It is to be noted the piece of porous material also has a closure function in maintaining the fluid product spaced from the vibratory plate in rest position.

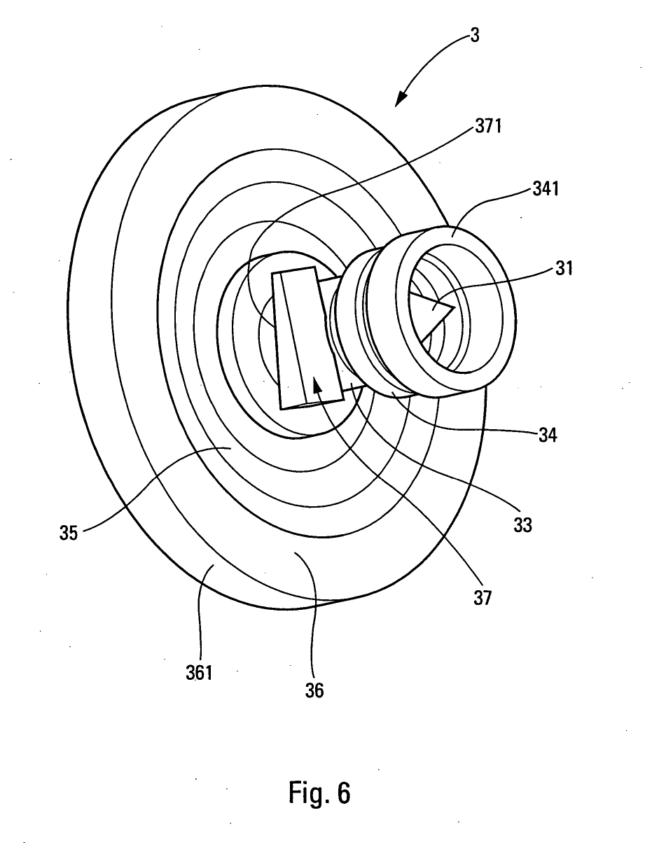

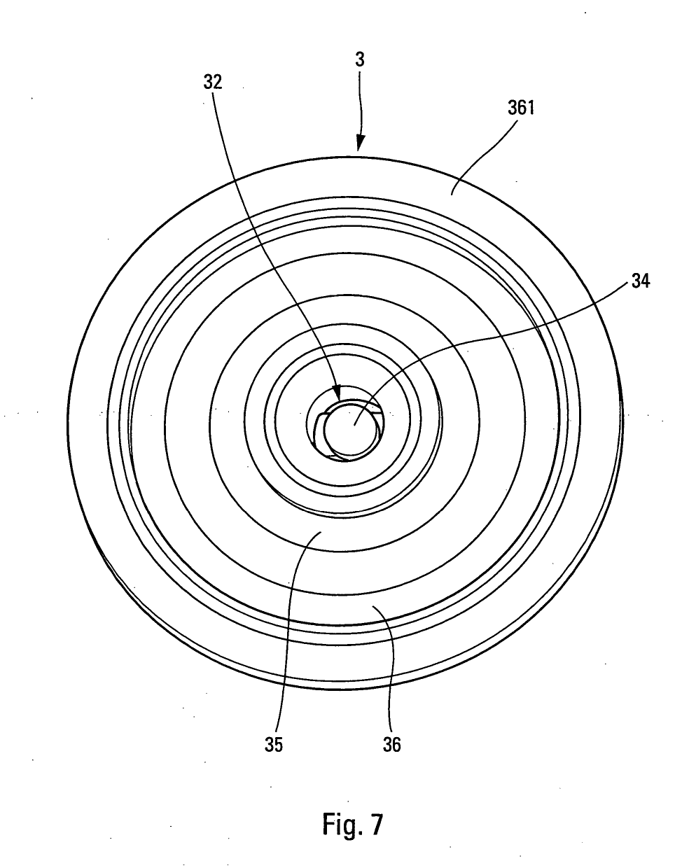

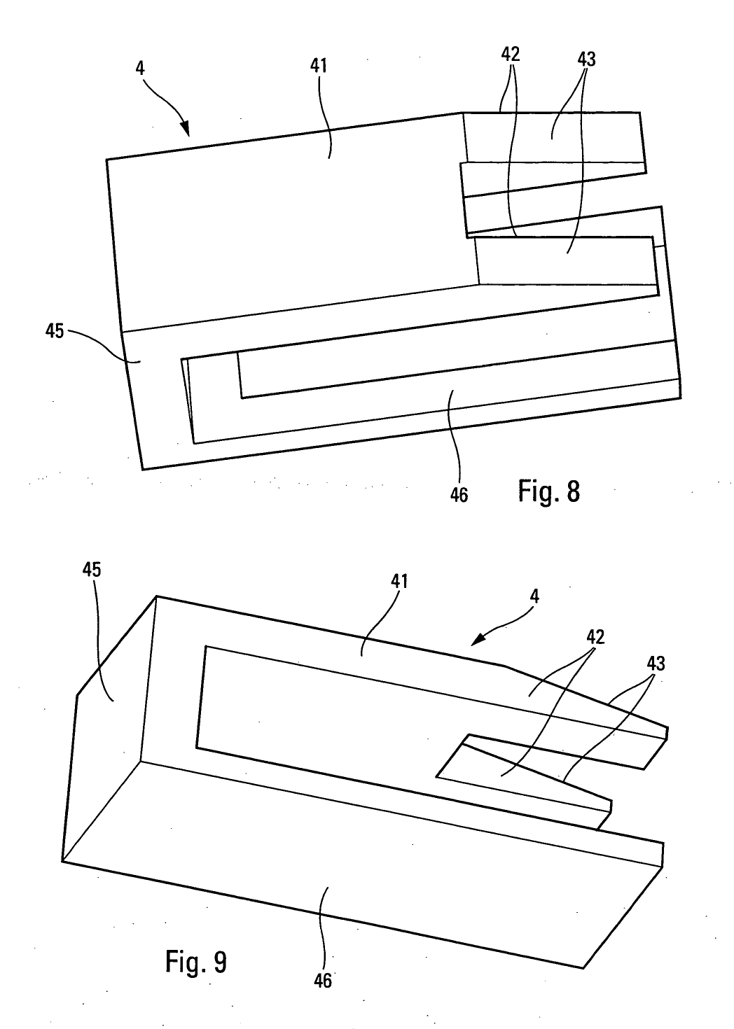

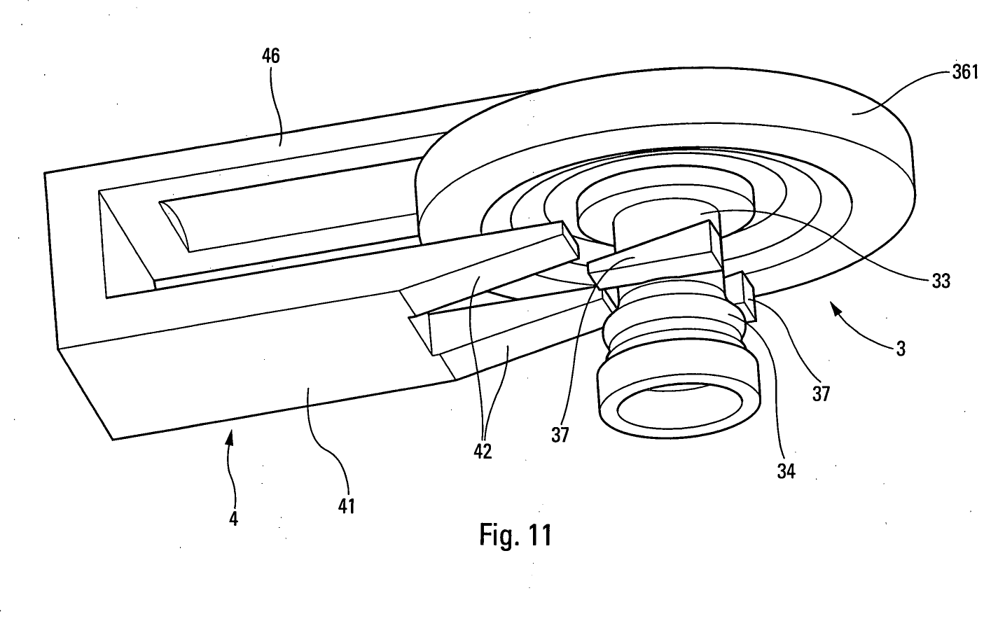

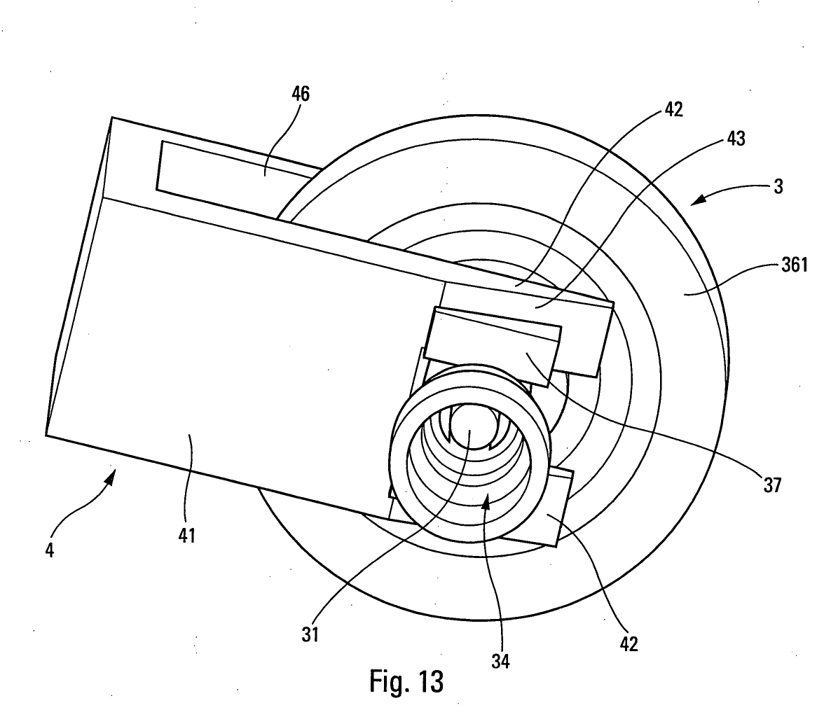

Advantageously, the actuating means 4, which can be seen clearly in FIGS. 8 and 9, are preferably made of integrally injection-molded plastic. The same applies for the support piece, which can be made of an integrally injection-molded flexible plastics material such as an elastomer thermoplastic. The support piece can be seen clearly from various angles in FIGS. 6 and 7. It is easy to understand how the actuating means 4 co-operate with the support piece 3 with reference to FIGS. 11 to 13.

In place of the above-described actuating means 4, it is also possible to use rotary actuating means, for example, in the form of a wheel forming a cam track on one of its faces that is suitable for coming into engagement with a corresponding cam element formed by the support piece 3. Thus, by turning wheel, a portion of the periphery of which is accessible from outside the dispenser, the cam element of the support piece 3 is urged to move the needle into engagement with its seat.

By means of the invention, it is guaranteed that the fluid dispenser cannot leak at the outlet of its feed duct 12.

1/ A fluid dispenser comprising:
a fluid reservoir (1);
at least one dispensing orifice through which the fluid is dispensed;
a fluid feed duct (12) connecting the reservoir (1) to the dispensing orifice, said duct being provided with an inlet and with an outlet;
a valve (31, 61) for selectively closing off the feed duct, said valve comprising a moving valve member (31) mounted to move between a passageway-closure position and a passageway-opening position, the moving valve member being mounted to be moved in translation along a valve axis; and
actuating means (4) for moving the moving valve member (31) between the passageway-closure position and the passageway-opening position;
said fluid dispenser being characterized in that the actuating means can be moved transversely to said valve axis, the actuating means comprising force-transmitting means (37, 42) suitable for transforming a force exerted on the actuating means into a transverse thrust force exerted on the moving valve member to move it towards its passageway-closure position.

2/ A dispenser according to claim 1, in which, the moving valve member comes into leaktight abutment against a fixed valve seat (61), formed at the outlet of the feed duct (12), when in the passageway-closure position, and remains away from said seat when in the passageway-opening position.

3/ A dispenser according to claim 1, in which the moving member is urged resiliently into the opening position by spring means (34).

4/ A dispenser according to claim 1, in which the force-transforming means comprise a cam system (37, 42).

5/ A dispenser according to claim 4, in which the cam system comprises a cam element (37) secured to the moving member (31) and a cam piece (42) formed by the actuating means.

6/ A dispenser according to claim 5, in which the cam piece (42) can be moved in translation and transversely relative to the cam element.

7/ A dispenser according to claim 5, in which the cam piece can be moved in rotation and transversely relative to the cam element.

8/ A dispenser according to claim 1, in which the actuating means (4) further comprising a control element (45) that is accessible from outside the dispenser.

9/ A dispenser according to claim 1, comprising a closure member (46) serving to come into place selectively in front of or behind said at least one dispensing orifice (22) to close it off.

10/ A dispenser according to claim 5, in which the cam piece (42) and the closure element (46) are constrained to move together.

11/ A dispenser according to claim 1, in which the actuating means (4) are made integrally as a single piece.

12/ A dispenser according to claim 1, in which the moving member (31) is secured to a support piece (3) on which a piece of porous material (30) is mounted that can be impregnated with fluid, said piece (30) being urged resiliently into contact with said at least one dispensing orifice (22).

13/ A dispenser according to claim 12, in which the support piece (3) is provided with common spring means (34) for simultaneously urging the piece of porous material (30) against said at least one dispensing orifice (22) and urging the moving member (31) into the passageway-opening position.

14/ A dispenser according to claim 12, in which the support piece (3) forms an outlet channel (32) connecting the outlet of the duct (12) to the piece of porous material (30), the moving member (31) being mounted inside said channel (32).

15/ A dispenser according to claim 14, in which the channel (32) has an elastically-deformable portion (34) making it possible to move the moving member (31) and the piece of porous material (30).

16/ A dispenser according to claim 12, in which the support piece (3) is provided with an elastically deformable diaphragm (36) having an outer peripheral edge (361) that is held in fixed manner, said diaphragm (36) moving the moving member (31) and the piece of porous material (30) in translation axially.

17/ A dispenser according to claim 1, further comprising a vibratory plate (2) that generates vibration in the fluid, said plate advantageously being vibrated by a piezoelectric element.

18/ A dispenser according to claim 17, in which said at least one dispensing orifice (22) is formed through the vibratory plate (2).

19/ A fluid dispenser comprising:
a fluid reservoir (1),
a fluid feed duct (12) connecting the reservoir (1) to dispensing orifices,
a vibratory plate (2) that generates vibration in the fluid, said plate advantageously being vibrated by a piezoelectric element, and
a closure member (46) serving to come into place selectively in front of or behind said at least one dispensing orifice (22) to close it off.

20/ A dispenser according to claim 19, in which said at least one dispensing orifice (22) is formed through the vibratory plate (2).
